(19) United States
(12) Patent Application Publication
(10) Pub. No.: US 2016/0188949 A1
(43) Pub. Date: Jun. 30, 2016

(54) FINGERPRINT SENSING DEVICE AND FINGERPRINT SENSING METHOD THEREOF

(71) Applicant: ELAN MICROELECTRONICS CORPORATION, Hsinchu (TW)

(72) Inventor: Chao-Chi Yang, Hsinchu City (TW)

(21) Appl. No.: 14/978,599

(22) Filed: Dec. 22, 2015

Related U.S. Application Data
(60) Provisional application No. 62/096,894, filed on Dec. 26, 2014.

(30) Foreign Application Priority Data
Nov. 26, 2015 (TW) 104139496

(51) Int. Cl. G06K 9/00

(52) U.S. Cl. CPC G06K 9/0002

(57) ABSTRACT

A fingerprint sensing device comprises a shielding plate configured between an electrode plate and a detection circuit for reducing a parasitic capacitor between the electrode plate and a conductor thereunder. Consequently, a larger signal dynamic range can be achieved and the electrode plate can be prevented from operation noise interference of the detection circuit. The shielding plate and the electrode plate have the same potential. Accordingly, a parasitic capacitor effect between the shielding plate and the electrode plate can be eliminated. Thus, the fingerprint sensing device of the present invention has a better noise resistibility.

### CROSS-REFERENCE TO RELATED APPLICATIONS

This application claims priority benefit of U.S. Provisional Patent Application Ser. No. 62/096,894, filed Dec. 26, 2014, and Taiwan Patent Application No. 104139496, filed Nov. 26, 2015, which are hereby incorporated by reference in its entirety.

### FIELD OF THE INVENTION

The present invention is related generally to a fingerprint sensing device and a method thereof, more particularly, to a low parasitic capacitance fingerprint sensing device and a fingerprint sensing method thereof.

### BACKGROUND OF THE INVENTION

FIG. 1 shows a conventional fingerprint sensing device 10. A protection layer 12 is provided for fingers to touch and for protecting electrode plates 16a, 16b, and 16c thereunder. An electro-static discharge (ESD) layer 14 provides an ESD protection. Detection circuits 18a, 18b, and 18c are connected to the electrode plates 16a, 16b, and 16c, respectively, thereby detecting a capacitance value between the electrode plates 16a, 16b, and 16c and a finger (not shown) so as to acquire a sensing voltage. Wherein, fingerprints of the finger consist of uneven lines. Thus, the fingerprints have peaks and valleys. Moreover, a distance between the peak of the fingerprint and the electrode plate is different from a distance between the valley of the fingerprint and the electrode plate, which also generates different sensing voltages. The fingerprint sensing device 10 judges the lines above the electrode plates 16a, 16b, and 16c are peaks or valleys according to the sensing voltages. After the fingerprint sensing device 10 acquires all the lines above the electrode plates, a fingerprint image of fingers can be acquired.

However, as shown by FIG. 1, there are parasitic capacitors Cp1a, Cp1b, and Cp1c between the electrode plates 16a, 16b, and 16c and conductors thereunder. The conductors under the electrode plates include detection circuits 18a, 18b, and 18c, a ground terminal, and other conductors. The parasitic capacitors Cp1a, Cp1b, and Cp1c will influence the sensing of the electrode plates 16a, 16b, and 16c. The larger the parasitic capacitors Cp1a, Cp1b, and Cp1c are, the smaller a dynamic range of the sensing voltage which is generated by measuring the electrode plates 16a, 16b, and 16c will be. Consequently, it will be more difficult to correctly judge that the line is peak or valley. Further, operation noise of the detection circuits 18a, 18b, and 18c also interferes with the electrode plates 16a, 16b, and 16c via the parasitic capacitor Cp1a, Cp1b, and Cp1c.

Therefore, it is desired a low parasitic capacitance fingerprint sensing device.

### SUMMARY OF THE INVENTION

An objective of the present invention is to provide a low parasitic capacitance fingerprint sensing device and a fingerprint sensing method thereof.

According to the present invention, a fingerprint sensing device comprises an electrode plate, a feedback capacitor, a component layer, and a shielding plate. The feedback capacitor is coupled to the electrode plate. The feedback capacitor and the electrode plate are independent components. The component layer is under the electrode plate. The component layer includes several circuit components connected to the feedback capacitor so as to form a detection circuit for detecting a capacitance value between a finger and the electrode plate. Accordingly, a fingerprint above the electrode plate can be judged by the capacitance value. The shielding plate is configured between the electrode plate and the component layer. In an exciting mode, a first voltage is provided to the electrode plate and the shielding plate. In a detecting mode, a second voltage is provided to the electrode plate and the shielding plate.

According to the present invention, a fingerprint sensing device comprises an electrode plate, a detection circuit, a first switch, and a shielding plate. In a detecting mode, the detection circuit detects a capacitance value between the electrode plate and a finger, wherein the capacitance value is used to judge a fingerprint above the electrode plate. The first switch is connected between the electrode plate and the detection circuit. The shielding plate is configured between the electrode plate and the detection circuit. In an exciting mode, the first switch is open so as to disconnect a connection between the electrode plate and the detection circuit and a first voltage is provided to the electrode plate and the shielding plate. In a detecting mode, the first switch is closed so as to make the detection circuit to connect the electrode plate and a second voltage is provided to the electrode plate and the shielding plate.

According to the present invention, a method for sensing fingerprints comprises the steps of: in an exciting mode, disconnecting a connection between an electrode plate and a detection circuit and providing a first voltage to the electrode plate and a shielding plate; and in a detecting mode, connecting the electrode plate to the detection circuit, providing a second voltage to the electrode plate and the shielding plate, detecting the capacitance value between a finger and the electrode plate by the detection circuit and judging a fingerprint above the electrode plate by the capacitance value. Wherein, the shielding plate is configured between the electrode plate and the detection circuit.

The present invention uses the shielding plate under the electrode plate to reduce the parasitic capacitor between the electrode plate and other conductors thereunder. Accordingly, a larger signal dynamic range can be achieved and the electrode plate can be prevented from operation noise interference of the detection circuit. Besides, since the shielding plate and the electrode plate have the same potential during the sensing, the parasitic capacitance effect between the shielding plate and the electrode plate can be eliminated.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 shows a conventional fingerprint sensing device;

FIG. 2 shows a first embodiment of a fingerprint sensing device of the present invention;

FIG. 3 shows a structure of the fingerprint sensing device in FIG. 2;

FIG. 4 shows an equivalent circuit of the fingerprint sensing device in FIG. 2 under an exciting mode;

FIG. 5 shows the equivalent circuit of the fingerprint sensing device in FIG. 2 under a detecting mode;

FIG. 6 shows timing diagrams of circuits in FIGS. 4 and 5; and

FIG. 7 shows a second embodiment of the fingerprint sensing device of the present invention.

### DETAILED DESCRIPTION OF THE INVENTION

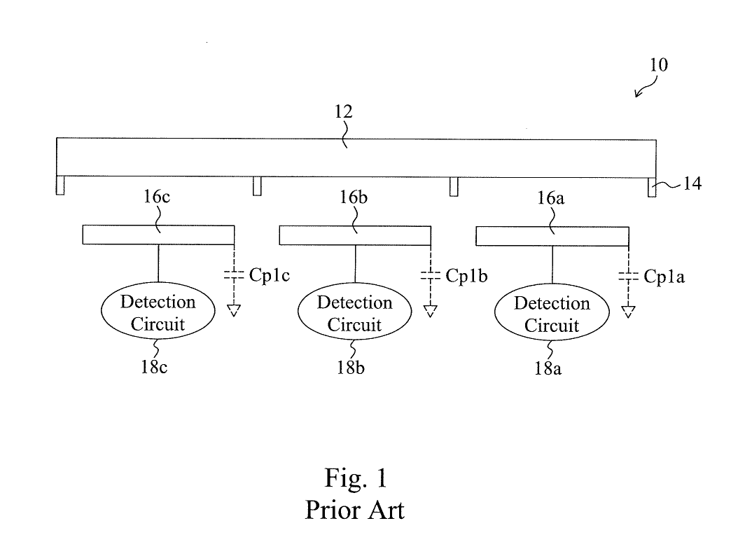

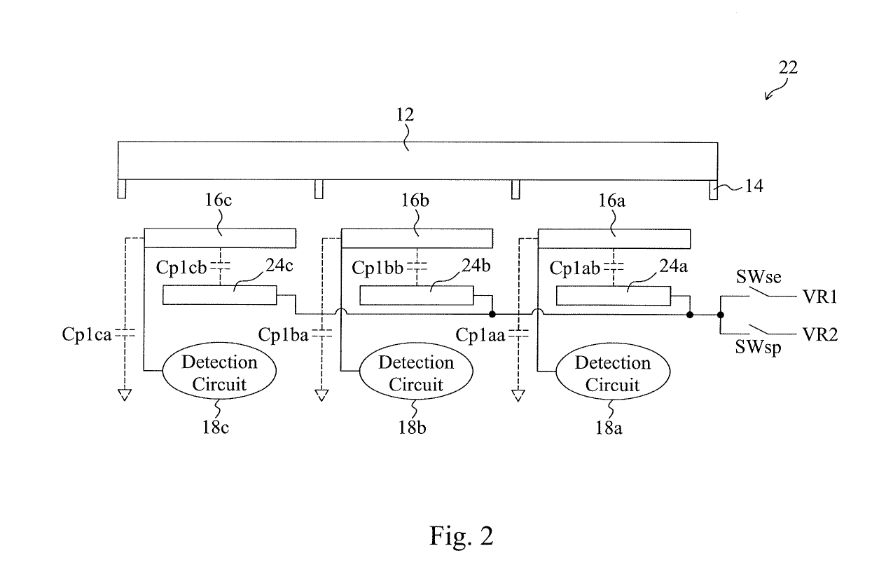

FIG. 2 shows an embodiment of a fingerprint sensing device 22 of the present invention, which comprises the similar protection layer 12, ESD layer 14, electrode plate 16a, 16b, and 16c, and detection circuits 18a, 18b, and 18c as those in the conventional fingerprint sensing device 10 in FIG. 1. Besides, the fingerprint sensing device 22 further comprises shielding plates 24a, 24b, and 24c, and switches SWse and SWsp. Wherein, the shielding plate 24a is configured between the electrode plate 16a and the detection circuit 18a. The shielding plate 24b is configured between the electrode plate 16b and the detection circuit 18b. The shielding plate 24c is configured between the electrode plate 16c and the detection circuit 18c. One terminal of the switch SWse is connected to the shielding plates 24a, 24b, and 24c. The other terminal of the switch SWse receives a voltage VR1. One terminal of the switch SWsp is connected to the shielding plates 24a, 24b, and 24c. The other terminal of the switch SWsp receives a voltage VR2. In the fingerprint sensing device 22, the shielding plates 24a, 24b, and 24c can reduce the parasitic capacitors between the electrode plates 16a, 16b, and 16c and other conductors (such as the detection circuits 18a, 18b, and 18c, and a ground) thereunder from Cp1a, Cp1b, and Cp1c in FIG. 1 to Cp1aa, Cp1ba, and Cp1ca. Wherein, the parasitic capacitors Cp1aa, Cp1ba, and Cp1ca are much smaller than the parasitic capacitors Cp1a, Cp1b, and Cp1c. Since the parasitic capacitors correspondent to the electrode plates 16a, 16b, and 16c are quite small, a larger signal dynamic range can be achieved to acquire a larger signal amount. Further, the shielding plates 24a, 24b, and 24c can lessen that the operation noise of the detection circuits 18a, 18b, and 18c interfere with the electrode plates 16a, 16b, and 16c. Moreover, by switching the switches SWse and SWsp, the shielding plates 24a, 24b, and 24c and the electrode plates 16a, 16b, and 16c have the same potential. As a result, during sensing the electrode plates 16a, 16b, and 16c, the effects of the parasitic capacitor Cp1ab, Cp1bb, and Cp1cb between the shielding plates 24a, 24b, and 24c and the electrode plates 16a, 16b, and 16c can be eliminated.

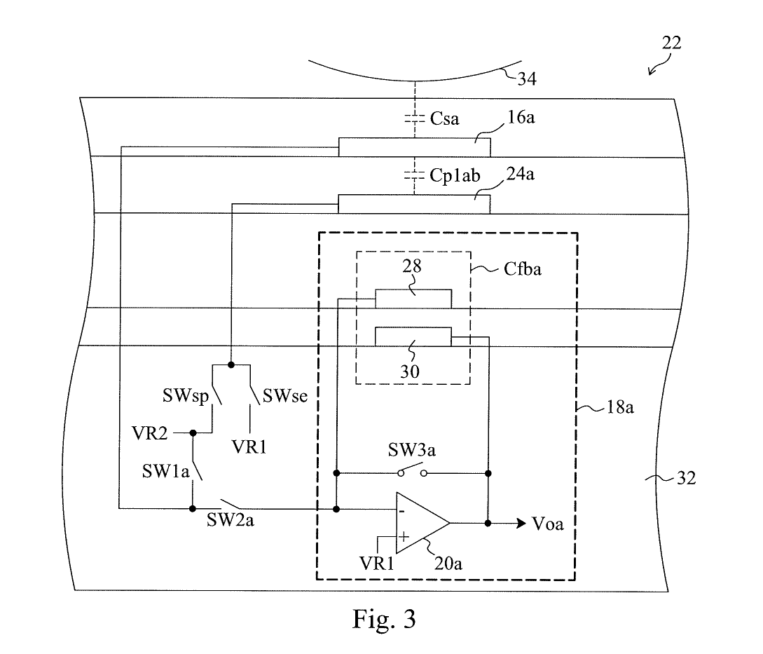

FIG. 3 shows an embodiment of a structure of the fingerprint sensing device 22 in FIG. 2. In this embodiment, for convenient illustration, only one sensing unit is shown. The sensing unit includes the electrode plate 16a, the detection circuit 18a, the shielding plate 24a, and switches SW1a, SW2a, SWse, and SWsp. In FIG. 3, switches SW1a, SW2a, SW3a, SWse, and SWsp and an operation amplifier 20a are disposed in a component layer 32. Wherein, the operation amplifier 20a, the switch SW3a and a feedback capacitor Cfba form the detection circuit 18a. The feedback capacitor Cfba is disposed between the shielding plate 24a and the component layer 32 and right under the shielding plate 24a. The feedback capacitor Cfba consists of metal plates 28 and 30, and the feedback capacitor Cfba and the electrode plate 16a are independent components. The shielding plate 24a is configured between the electrode plate 16a and the component layer 32. The shielding plate 24a is disposed right under the electrode plate 16a so as to reduce the parasitic capacitor between electrode plate 16a and other conductors (such as the detection circuit 18a and the ground) thereunder. The component layer 32 further includes a semi-conductor substrate (not shown) for manufacturing the components of the detection circuit 18a. The feedback capacitor Cfba can be formed by other means. For example, the feedback capacitor Cfba can be formed by two layers of Polysilicon in the component layer 32.

When a finger 34 touches the fingerprint sensing device 22, a capacitor Csa will be generated between the finger 34 and the electrode plate 16a. Accordingly, detecting the capacitor Csa can judge that a line of a fingerprint above the electrode plate 16a is peak or valley. In an exciting mode, switches SW1a, SW3a, and SWsp are closed (on), and switches SW2a and SWse are open (off). At this time, the voltage VR2 is provided to the electrode plate 16a and the shielding plate 24a, and the feedback capacitor Cfba is in a short circuit state. Therefore, the voltage on the feedback capacitor Cfba is set as 0V. In a detecting mode, switches SW1a, SW3a and SWsp are open, and switches SW2a and SWse are closed. Accordingly, the electrode plate 16a and the shielding plate 24a are connected to an invert input terminal of an operation amplifier 20a and the voltage VR1, respectively. Since the operation amplifier has a characteristic of virtual ground, the voltage VR1 is also provided to the electrode plate 16a. In the meantime, the detection circuit 18a detects the capacitor Csa to generate a sensing voltage Voa to judge that the line above the electrode plate 16a is peak or valley. In both the exciting mode and the detecting mode, the potentials of the electrode plate 16a and the shielding plate 24a are the same. Consequently, the effect of the parasitic capacitor Cp1ab between the electrode plate 16a and the shielding plate 24a will be eliminated.

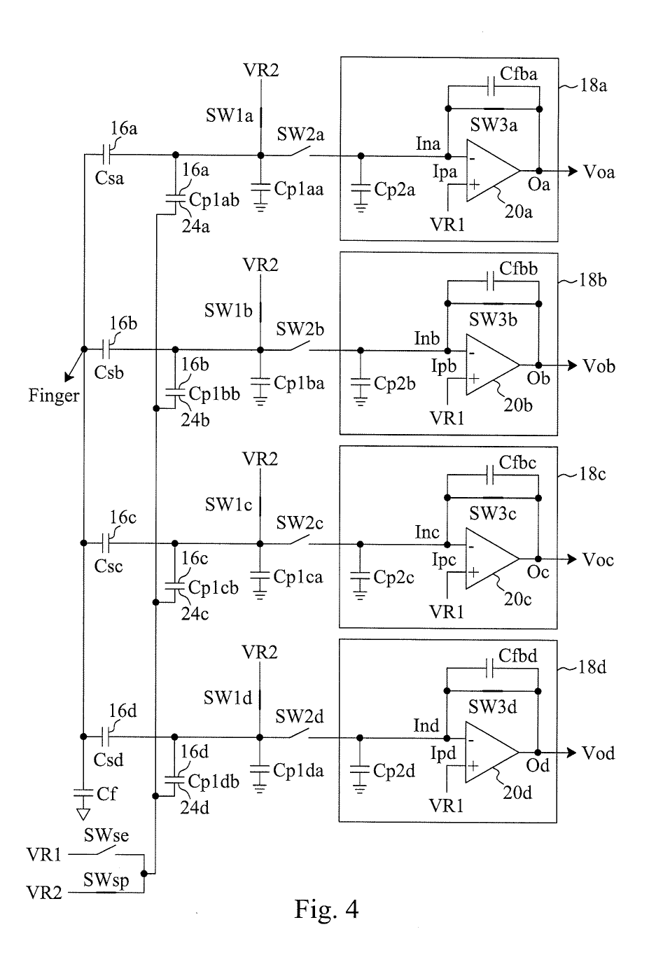

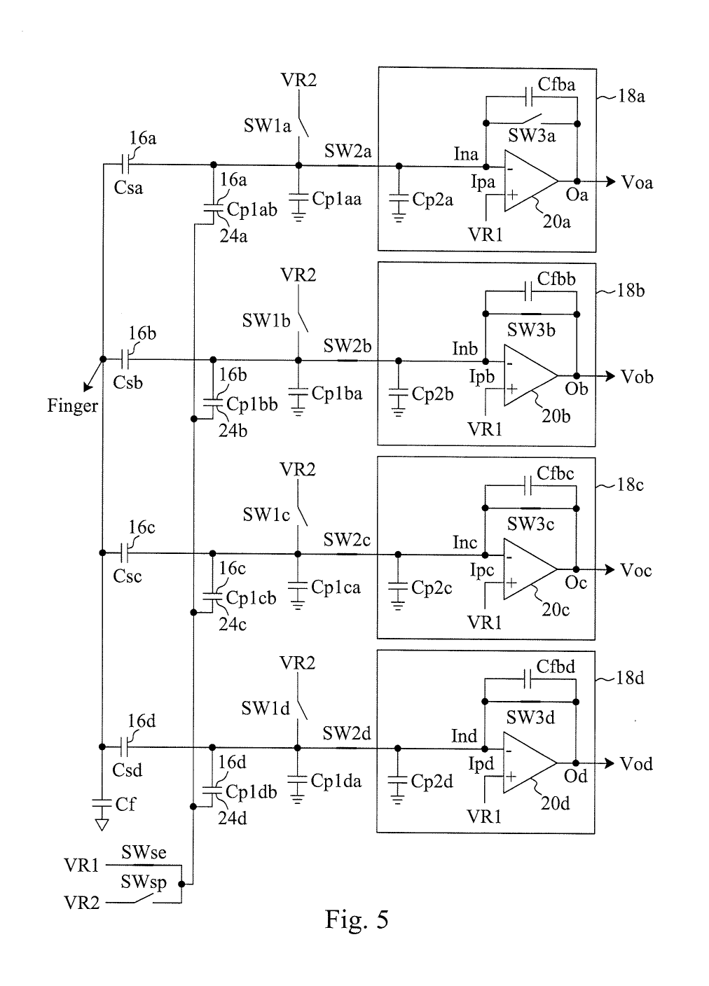

FIGS. 4 and 5 show equivalent circuits of the fingerprint sensing device 22 in FIG. 2. Wherein, FIG. 4 shows an operation in the exciting mode, and FIG. 5 shows an operation in the detecting mode. In FIGS. 4 and 5, Csa, Csb, Csc, and Csd are capacitors formed by a finger and the electrode plates 16a, 16b, 16c, and 16d. The electrode plates 16a, 16b, 16c, and 16d are regarded as the right electrodes of the capacitors Csa, Csb, Csc, and Csd, respectively. The finger is regarded as the left electrodes of the capacitors Csa, Csb, Csc, and Csd. One terminal of the switch SW is connected to the electrode plate 16a and the switch SW2a. The other terminal of the switch SW1a receives the voltage VR2. The switch SW2a is connected between the electrode plate 16a and the detection circuit 18a. Cp1aa represents the parasitic capacitor between the electrode plate 16a and the conductors thereunder. Cp1ab is the parasitic capacitor between the electrode plate 16a and the shielding plate 24a. The detection circuit 18a includes the operation amplifier 20a, the switch SW3a, and the feedback capacitor Cfba. Wherein, the switch SW3a and the feedback capacitor Cfba are a parallel connection between an invert input terminal Ina and an output terminal Oa of the operation amplifier 20a. A non-invert input terminal Ipa of the operation amplifier 20a receives the voltage VR1. The capacitor Cp2a represents the parasitic capacitor of the invert input terminal Ina of the operation amplifier 20a. One terminal of a switch SW1b is connected to the electrode plate 16b and a switch SW2b. The other terminal of the switch SW receives the voltage VR2. The switch SW2b is connected between the electrode plate 16b and the detection circuit 18b. Cp1ba represents the parasitic capacitor between the electrode plate 16b and the conductors thereunder. Cp1bb is the parasitic capacitor between the electrode plate 16b and the shielding plate 24b. The detection circuit 18b includes an operation amplifier 20b, a switch SW3b, and a feedback capacitor Cfbb. Wherein, the switch SW3b and the feedback capacitor Cfbb are a parallel connection between an invert input terminal Inb and an output terminal Ob of the operation amplifier 20b. A non-invert input terminal Ipb of the operation amplifier 20b receives the voltage VR1. The capacitor Cp2b represents is the parasitic capacitor of the invert input terminal Inb of the operation amplifier 20b. One terminal of a switch SW1c is connected to the electrode plate 16c and the switch SW2c. The other terminal of the switch SW1c receives the voltage VR2. The switch SW2c is connected between the electrode plate 16c and the detection circuit 18c. Cp1ca represents the parasitic capacitor between the electrode plate 16c and the conductors thereunder. Cp1cb is the parasitic capacitor between the electrode plate 16c and the shielding plate 24c. The detection circuit 18c includes an operation amplifier 20c, a switch SW3c, and a feedback capacitor Cfbc. Wherein, the switch SW3c and the feedback capacitor Cfbc are a parallel connection between an invert input terminal Inc and an output terminal Oc of the operation amplifier 20c. A non-invert input terminal Ipc of the operation amplifier 20c receives the voltage VR1. The capacitor Cp2c represents the parasitic capacitor of the invert input terminal Inc of the operation amplifier 20c. One terminal of a switch SW1d is connected to the electrode plate 16d and a switch SW2d. The other terminal of the switch SW1d receives the voltage VR2. The switch SW2d is connected between the electrode plate 16d and the detection circuit 18d. Cp1da represents the parasitic capacitor between the electrode plate 16d and the conductors thereunder. Cp1db is the parasitic capacitor between the electrode plate 16d and the shielding plate 24d. The detection circuit 18d includes an operation amplifier 20d, a switch SW3d, and a feedback capacitor Cfbd. Wherein, the switch SW3d and the feedback capacitor Cfbd are a parallel connection between an invert input terminal Ind and an output Od of the operation amplifier 20d. A non-invert input terminal Ipd of the operation amplifier 20d receives the voltage VR1. The capacitor Cp2d represents the parasitic capacitor of the invert input terminal Ind of the operation amplifier 20d. In FIGS. 4 and 5, there are the shielding plates 24a, 24b, 24c, and 24d between the electrode plates 16a, 16b, 16c, and 16d and the detection circuits 18a, 18b, 18c, and 18d, so the parasitic capacitors between the electrode plates 16a, 16b, 16c, and 16d and other conductors thereunder are lowering from Cp1a, Cp1b, and Cp1c in FIG. 1 to Cp1aa, Cp1ba, Cp1ca, and Cp1da. The parasitic capacitors Cp1aa, Cp1ba, Cp1ca, and Cp1da are much smaller than the parasitic capacitors Cp1a, Cp1b, and Cp1c.

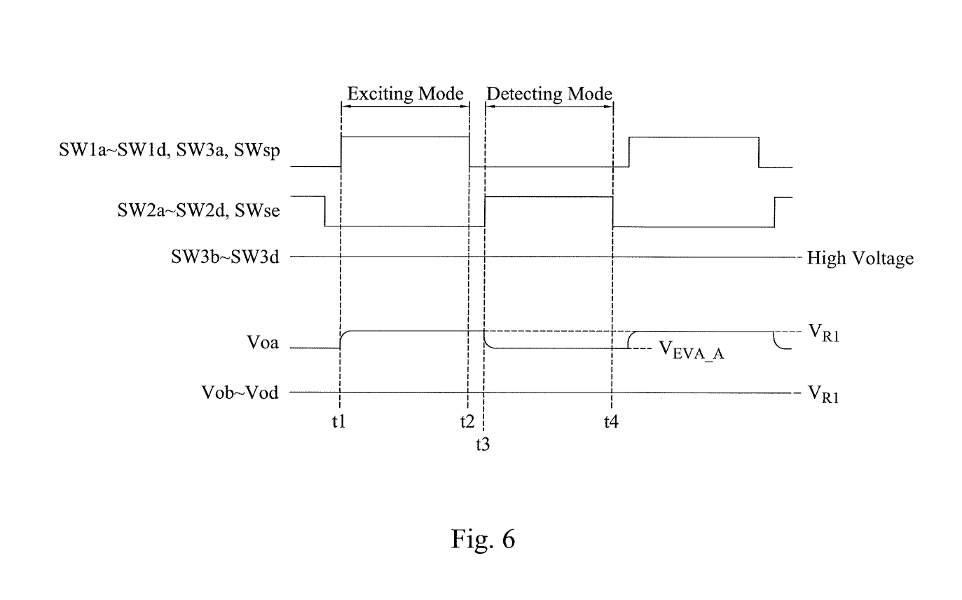

FIG. 6 shows timing diagrams of the circuits under detecting the electrode plate 16a in FIGS. 4 and 5. As shown by the circuits in FIG. 4 and time t1˜t2 in FIG. 6, when the fingerprint sensing device 22 is in the exciting mode, switches SW1a, SW3a, SW1b, SW3b, SW1c, SW3c, SW1d, SW3d, and SWsp are closed (on), and switches SW2a, SW2b, SW2c, SW2d, and SWse are open (off). In the meantime, the voltage VR2 charges the capacitors Csa, Csb, Csc, and Csd, and the voltages of the feedback capacitors Cfba, Cfbb, Cfbc, and Cfbd are 0V. Since the operation amplifier has a characteristic of virtual ground, the voltages of the invert input terminals Ina, Inb, Inc, and Ind of the operation amplifiers 20a, 20b, 20c, and 20d equal VR1. The output terminals Oa, Ob, Oc, and Od of the operation amplifiers 20a, 20b, 20c, and 20d are connected to the invert input terminals Ina, Inb, Inc, and Ind, so sensing voltages Voa, Vob, Voc, and Vod will equal VR1. In the exciting mode, the potentials at two terminals of the parasitic capacitors Cp1ab, Cp1bb, Cp1cb, and Cp1db are VR2. Thus, the voltages of the parasitic capacitors Cp1ab, Cp1bb, Cp1cb, and Cp1db are 0V. When the exciting mode ends as shown by the time t2 in FIG. 6, the switches SW1a, SW3a, SW1b, SW1c, SW1d, and SWsp are became open. Switches SW2a, SW2b, SW2c, SW2d, and SWse are kept open. Switches SW3b, SW3c, and SW3d are kept closed.

As shown by the circuits in FIG. 5 and time t3˜t4 in FIG. 6, when the fingerprint sensing device 22 enters the detecting mode for detecting the fingerprint corresponding to the electrode plate 16a, switches SW1a, SW3a, SW1b, SW1c, SW1d, and SWsp are kept open. Switches SW2a, SW2b, SW2c, SW2d, and SWse are became closed. Switches SW3b, SW3c, and SW3d are kept closed. In the meantime, the sensing voltage Voa=VR1−(VR2−VR1)×[(Csa/Cfba)+(Cp1aa/Cfba)]. The fingerprint sensing device 22 determines the capacitance value of the capacitor Csa according to the sensing voltage Voa so as to judge that the line corresponding to the electrode plate 16a is peak or valley. When the detecting mode ends as shown by time t4 in FIG. 6, switches SW1a, SW3a, SW1b, SW1c, SW1d, and SWsp are kept open. Switches SW2a, SW2b, SW2c, SW2d, and SWse are became open. Switches SW3b, SW3c, and SW3d are kept closed. In the detecting mode, due to the virtual ground of the operation amplifier, the potentials at two terminals of the parasitic capacitors Cp1ab, Cp1bb, Cp1cb, and Cp1db are VR1. From aforementioned equation of the sensing voltage Voa, the parasitic capacitor Cp1ab between the electrode plate 16a and the shielding plate 24a does not influence the sensing voltage Voa. Moreover, there is only the very small parasitic capacitor Cp1aa between the electrode plate 16a and the conductors thereunder. Thus, the fingerprint sensing device 22 of the present invention has a larger signal dynamic range than that of the conventional fingerprint sensing device 10 with the larger parasitic capacitor Cp1a. As a result, the present invention provides a larger output signal amount. Additionally, the present invention also can lessen that the operation noises of the detection circuits influence the electrode plates. Further, the switches in the figures can be configured under the electrode plates and the shielding plates. Namely, the present invention also lessen that the operation noises of the switches influence the electrode plates.

In FIG. 6, during the process from the exciting mode to the detecting mode, switches SW1a, SW3a, SW1b, SW1c, SW1d, and SWsp will be opened before switches SW2a, SW2b, SW2c, SW2d, and SWse are closed.

FIG. 5 shows an example of measuring the capacitor Csa between the electrode plate 16a and the finger. People skilled in the art know how to measure the other electrode plates properly, which will be hereby omitted.

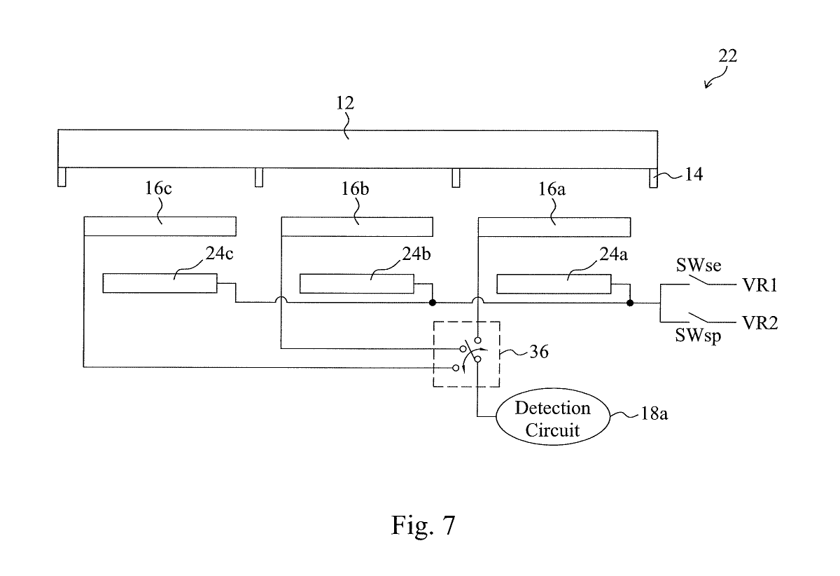

In the fingerprint sensing device 22 in FIG. 2, each of the electrode plates 16a, 16b, and 16c is corresponding to each of the detection circuits 18a, 18b, and 18c, respectively. In other embodiments, the electrode plates 16a, 16b, and 16c can share one detection circuit 18a as shown by FIG. 7. In FIG. 7, a switching circuit 36 is connecting the detection circuit 18a to the detected electrode plates 16a, 16b, or 16c.

In the embodiments in FIGS. 2, 4, 5, and 7, the shielding plates 24a, 24b, 24c, and 24d share the switches SWse and SWsp. In other embodiments, one shielding plate can correspond to one set of switches SWse and SWsp.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A fingerprint sensing device, comprising:
an electrode plate;
a feedback capacitor coupled to the electrode plate, wherein the feedback capacitor and the electrode plate are independent components;
a component layer under the electrode plate including several circuit components that are connected to the feedback capacitor, wherein the several circuit components and the feedback capacitor form a detection circuit for detecting a capacitance value between a finger and the electrode plate, and the capacitance value is used to judge a fingerprint above the electrode plate; and
a shielding plate configured between the electrode plate and the component layer;
wherein, in an exciting mode, a first voltage is provided to the electrode plate and the shielding plate and in a detecting mode, a second voltage is provided to the electrode plate and the shielding plate.

2. The fingerprint sensing device of claim 1, wherein the several circuit components comprise:
an operation amplifier having an invert input terminal, a non-invert input terminal which receives the second voltage, and an output terminal; and
a first switch connected to the feedback capacitor in parallel between the invert input terminal and the output terminal of the operation amplifier, wherein in the exciting mode, the first switch is closed and in the detecting mode, the first switch is open.

3. The fingerprint sensing device of claim 2, wherein the component layer further comprises:
a second switch having one terminal connected to the invert input terminal of the operation amplifier and the other terminal connected to the electrode plate, wherein in the exciting mode, the second switch is open and in the detecting mode, the second switch is closed;
a third switch having one terminal connected to the second switch and the electrode plate and the other terminal for receiving the first voltage, wherein in the exciting mode, the third switch is closed and in the detecting mode, the third switch is open;
a fourth switch having one terminal connected to the shielding plate and the other terminal for receiving the first voltage, wherein in the exciting mode, the fourth switch is closed and in the detecting mode, the fourth switch is open; and
a fifth switch having one terminal connected to the shielding plate and the other terminal for receiving the second voltage, wherein in the exciting mode, the fifth switch is open, and in the detecting mode, the fifth switch is closed.

4. A fingerprint sensing device, comprising:
an electrode plate;
a detection circuit for detecting a capacitance value between the electrode plate and a finger in a detecting mode, wherein the capacitance value is used to judge a fingerprint above the electrode plate;
a first switch connected between the electrode plate and the detection circuit, wherein in an exciting mode, the first switch is open for disconnecting a connection between the electrode plate and the detection circuit and in a detecting mode, the first switch is closed for connecting the detection circuit to the electrode plate; and
a shielding plate configured between the electrode plate and the detection circuit;
wherein, in the exciting mode, a first voltage is provided to the electrode plate and the shielding plate and in the detecting mode, a second voltage is provided to the electrode plate and the shielding plate.

5. The fingerprint sensing device of claim 4, wherein the detection circuit comprises:
an operation amplifier having an invert input terminal, a non-invert input terminal which receives the second voltage, and an output terminal;
a feedback capacitor connected between the invert input terminal and the output terminal;
a second switch connected to the feedback capacitor in parallel, wherein in the exciting mode, the second switch is closed and in the detecting mode, the second switch is open.

6. The fingerprint sensing device of claim 5, further comprising:
a third switch having one terminal connected to the first switch and the electrode plate and the other terminal for receiving the first voltage, wherein in the exciting mode, the third switch is closed and in the detecting mode, the third switch is open;
a fourth switch having one terminal connected to the shielding plate and the other terminal for receiving the first voltage, wherein in the exciting mode, the fourth switch is closed and in the detecting mode, the fourth switch is open; and
a fifth switch having one terminal connected to the shielding plate and the other terminal for receiving the second voltage, wherein in the exciting mode, the fifth switch is open, and in the detecting mode, the fifth switch is closed.

7. A method for sensing fingerprints, comprising the steps of:
in an exciting mode, disconnecting a connection between an electrode plate and a detection circuit and providing a first voltage to the electrode plate and a shielding plate; and
in a detecting mode, connecting the electrode plate to the detection circuit and providing a second voltage to the electrode plate and the shielding plate, wherein the detection circuit detecting a capacitance value between a finger and the electrode plate and the capacitance value is used to judge that a fingerprint above the electrode plate;
wherein, the shielding plate is configured between the electrode plate and the detection circuit.

8. The method of claim 7, further comprising the steps of:
setting a voltage of a feedback capacitor connected between an invert input terminal and an output terminal of an operation amplifier in the detection circuit in an exciting mode; and
connecting the feedback capacitor to the electrode plate in a detecting mode so as to make the feedback capacitor to generate a sensing voltage for judging the fingerprint above the electrode plate, wherein the sensing voltage is related to the capacitance value between the finger and the electrode plate.
